(19) United States
(12) Patent Application Publication
(10) Pub. No.: US 2002/0014468 A1
(43) Pub. Date: Feb. 7, 2002

(54) Stoppers for containers, such as wine bottles, and corresponding accessory

(76) Inventor: Fernando Stroppiana, Cavour (Cuneo) (IT)

Correspondence Address: TRASK BRITT, P.O. BOX 2550, SALT LAKE CITY, UT, 84110, US

(21) Appl. No.: 09/872,112

(22) Filed: Jun. 1, 2001

(30) Foreign Application Priority Data
Aug. 1, 2000 (IT) T02000A000765

(51) Int. Cl. B27M 3/00

(52) U.S. Cl. 215/355; 428/35.6

(57) ABSTRACT

A stopper for containers, such as wine bottles, comprises:

a core made of a natural material, such as cork; and

a coating or jacket made of synthetic material, such as plastics, which is adapted to coat said core (2) at least in the parts designed to co-operate with the container to obtain sealed closing of the container itself. The jacket may constitute an independent accessory which can be fitted to said core before use of the stopper.

The present invention relates to stoppers for containers and has been developed with particular attention paid to the possible application to stoppers for wine bottles.

The solution traditionally adopted for making stoppers of the specified type involves recourse, as material of choice, to natural cork.

The availability of this material, in particular as regards high-quality material, tends, however, to be increasingly inadequate as compared to the demand, this fact having led, among other things, to a gradual rise in the prices.

Alongside this, stoppers made of cork are intrinsically subject to the problem of potentially giving rise to a bad taste of wine (the typical “corked” taste) on account of the possible presence of 2,4,6-trichloroanisole (TCA), which is a natural chemical compound found in cork lignin.

According to recent data, the above phenomenon is statistically important (the possible incidence thereof being estimated at between 2 and 15% of the world production of wine) Furthermore, the phenomenon is hard to foresee as regards its occurrence in so far as it is likely to be induced by the possible presence of spores according to a highly variable spatial distribution, and hence difficult to identify using methods of control.

For the above reason, over the last few years much research has been carried out on alternative materials which may be used for making stoppers, in particular for wine bottles.

The research activities in this field, with a certain degree of oversimplification, but at the same time with substantial adherence to the actual facts, can be said to follow two main lines.

The first line (documented, for example, in documents such as U.S. Pat. No. 5,480,915, U.S. Pat. No. 5,496,862, U.S. Pat. No. 5,692,629, U.S. Pat. No. 5,710,184, and U.S. Pat. No. 5,855,287) is essentially based on the use, for making stoppers, of synthetic materials, such as thermoplastic elastomers, usually containing swelling agents.

This type of solution, however, comes up against a certain number of difficulties.

It is desirable, in fact, that the stopper made of synthetic material should present all the positive qualities that a stopper made of natural cork does, without presenting the drawbacks of the latter.

This means that it is desirable to have, for example, the same characteristics of interaction with the corkscrew (precise and easy penetration of the helix of the corkscrew into the stopper, without phenomena of tearing and fragmentation when the stopper is pulled out, etc.) as those of a good stopper made of natural cork, and at the same time the characteristics of proper insulation and seal, absolute repeatability of the physical and mechanical characteristics, absence of appreciable surface porosity, etc., that are likely to derive from the use of a synthetic material.

This involves, on the one hand, the need to resort to materials that are on the whole costly, also on account of the treatments which they must undergo, and, on the other hand, the need to adopt compromise solutions in any case. This applies in particular to the bottling operation: most stoppers made of synthetic material tend, by and large, to be rather stiff. This means that stoppers made of synthetic material have, in the absence of stresses (hence before bottling), dimensions which are, on the whole, smaller than the homologous dimensions of stoppers made of natural cork. Moreover, the operation of compression linked to the bottling operation takes place according to a mechanism which is quite different from that involved when stoppers made of natural cork are used. This means, among other things that one and the same bottling line cannot be easily converted from operating with stoppers made of natural cork to operating with stoppers made of synthetic material.

To be added to this is the fact that some of the swelling agents used for making synthetic stoppers, such as azodicarbonamide, call for particular precautions when used in the industrial sphere.

First and foremost, however, is the fact that the use of stoppers made of plastic material (the appearance of which is in any case discernible from stoppers made of natural cork) is hard to propose in certain sectors of the wine industry, in particular as regards the bottling of high-quality wines.

The other line of innovation, documented, for example, by U.S. Pat. No. 5,317,047, aims at making stoppers having a, so to speak, mixed structure, i.e., a structure made of a natural material, such as cork or wood, in the form of a particulate dispersed in a matrix of synthetic material, with the use of additives, such as binders, lubricants, etc.

In addition to presenting a fair number of the drawbacks described previously, this solution comes up against the intrinsic difficulty linked to the fact of seeking to bestow on the composite material the characteristics of natural cork. In particular, this regards the mechanism of interaction between the stopper and the corkscrew, above all as concerns the possible risks of fragmentation or breaking of the stopper when it is being pulled out.

The purpose of the present invention is to provide an alternative solution that is able to overcome the drawbacks outlined above.

According to the present invention, the above purpose is achieved by a stopper having the characteristics specifically called for in the claims wich follow. The invention also relates to the corresponding accessory, which, combined with a stopper having an overall traditional structure, enables implementation of the invention.

In brief, the solution according to the invention is based on the general criterion of using natural cork to ensure the intrinsic characteristics of compliance, elasticity, and good co-operation with the corkscrew that are typical of a traditional material, resorting, instead, to a synthetic material for the outer part of the stopper, hence with exploitation for this purpose of the characteristics of absence of risks of contamination by agents such as trichloroanisole, good sealing, and absolute repeatability of the characteristics of operation that are intrinsic in the use of a plastic material.

Allied to the above features is the further advantage of being able, on the one hand, to extend considerably the range of choice of the synthetic materials that may be used (with the only practical limitation represented by the fact that it is necessary for the materials to be acceptable for contact with foodstuffs, i.e., the so-called “food-approved materials”), and with the further possibility of making the outer appearance of the stopper, at least as regards the parts directly visible from outside the bottle, altogether identical to that of a stopper made of natural cork.

The present invention will now be described, purely by way of non-limiting example, with reference to the annexed drawings comprising three figures which represent three possible embodiments of a stopper according to the invention.

In the attached drawings, the reference number 1 designates a stopper that may be used, for example, for closing a wine bottle or a similar container designed to contain products, such as, typically, foodstuffs.

The objects in question are generally bodies having a cylindrical shape, with just to provide an indication a diameter in the region of 25 mm and a height in the region of 50 mm.

Of course, above all as regards the diameter, the above dimensions apply to the stopper 1 in the absence of stresses, i.e., before the stopper is compressed radially to be inserted into the neck part of a corresponding bottle or similar container (not illustrated in the drawings).

The stopper 1 according to the invention essentially comprises two parts:

a core 2, defining the central/inner part of the stopper 1, consisting of a natural material, such as, typically, natural cork; and

an outer coating or jacket 3 of synthetic material that encloses the core part 2, at least in the parts designed to co-operate with the container to obtain the desired relationship of sealed closing.

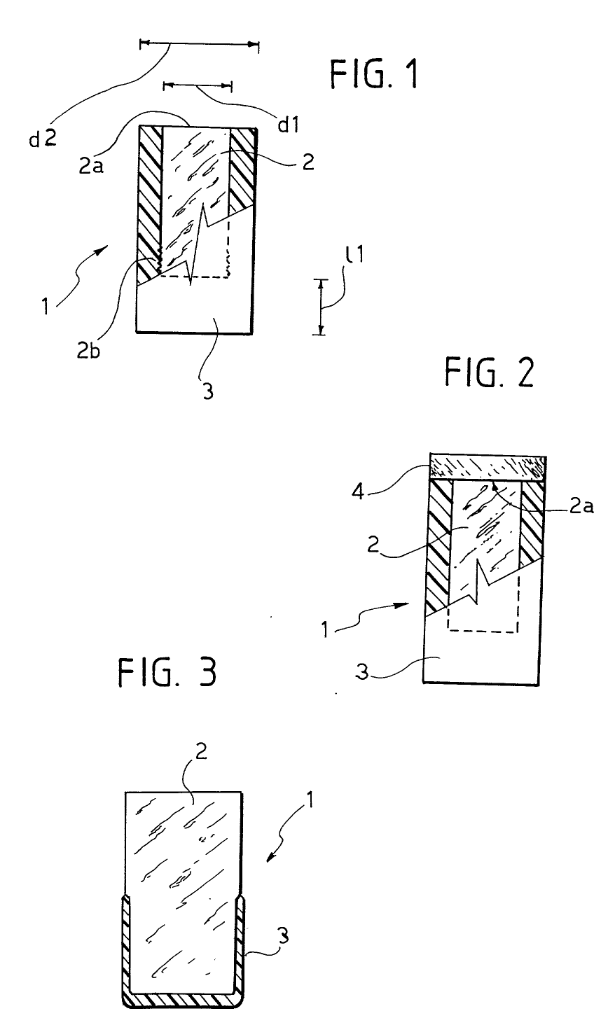

In the embodiment represented in FIG. 1, the jacket 3 made of synthetic material (typically, a plastic material) coats the entire outer surface or skirt of the core 2, as well as one of the end surfaces, hence leaving the opposite end, designated by 2a, free.

The said end is, in the normal condition of use, the one designed to face towards the outside of the container so as to be exposed, for example, to the action of penetration of an implement for removing stoppers, such as, typically, a corkscrew.

In the variant embodiment represented in FIG. 2, the end surface 2a is coated with a disk-like element or washer 4 made of natural material, such as natural cork, which is not necessarily identical, but on the whole similar, to the material making up the cork 2.

The embodiment represented in FIG. 3 is structurally similar to that of FIG. 1. However, in the solution of FIG. 3 the coating or jacket 3 assumes the form of a sheath which is, on the whole, thin and is designed to envelop the surface of the skirt of the core 2 for its entire extension, or—according to the currently preferred embodiment—for a part comprised between approximately one third and approximately one half of the overall axial extension of the core 2.

Preferably, the core 2 has a cylindrical shape and is smooth on the outside.

Optionally, as is schematically illustrated by the dashed line in FIG. 1, the core part 2 may have hooking formations 2b which project and/or are recessed and are able to provide mechanical anchorage in regard to the jacket 3.

Likewise, it may be hypothesized that instead of presenting a cylindrical shape, the core 2 has a different shape, for example a grooved shape, or a star shape, etc., the aim being to obtain a more intimate connection between the core 2 and the jacket 3.

The experiments so far conducted by the Applicant show, however, that recourse to such hook-type configurations is not imperative.

The simple operation of moulding the jacket 3 on the core 2 (for instance, by a normal process of injection moulding, preferably accompanied by a certain immission of gas, such as helium, air, or other appropriate gas, into the moulded mass) is, on the other hand, such as to give rise to a relationship of firm anchorage between the core 2 and the jacket 3.

The same applies also to the solution represented in FIG. 3, where the jacket 3, which may be made as an accessory in itself, is fitted onto the core 2 by a simple operation of insertion. Advantageously, this operation may be performed when the stopper is inserted into the corresponding container (bottle). This is done preferably by placing the jacket 3 in the path of insertion of the stopper into the bottle. In particular, the jacket 3 is placed immediately at the outlet of the part of the bottling machine in which the stopper is radially compressed. The stopper thus compressed penetrates into the open part of the jacket 3, which is thus fitted onto the stopper to be then drawn by the stopper itself into the position of insertion into the neck of the bottle.

This anchorage however achieved is such as to ensure that during extraction (which is an operation that usually involves the penetration of the helix of the corkscrew into the core 2 and the subsequent application of a strong axial load in the direction ideally corresponding to the extraction of the core with respect to the jacket 3) there does not arise any phenomenon of detachment or even only of weakening of the bond between the core 2 and the jacket 3.

As far as the choice of the constituent materials is concerned, the material of choice for the core 2 is of course natural cork. Since the core 2 is in any case to be enclosed in the coating or jacket 3, it is possible to use, for making the core 2, types of cork that have a certain degree of porosity and/or characteristics that would be considered, however, not optimal for making a stopper totally made up of this material.

In this regard, it is important at the same time that the characteristics of the stopper 1 as a whole should not be jeopardized. In particular, the jacket 3 is able to ensure a virtually perfect sealing action, without any risk of leakage from or to the inside of the container through the passage between the stopper 1 and the neck of the container, at the same time avoiding the possibility of the risk of any phenomena of assumption or release as regards the substance (typically wine) present in the container.

The above applies also to the embodiment represented in FIG. 3. The experiments conducted by the applicant prove in fact that the aforesaid results/advantages may be obtained also by limiting the coverage of the skirt surface of the core 2 to a portion of a certain length (typically between one third and one half of the total) adjacent to the end inserted in the container.

The mechanical characteristics of the stopper 1, in particular as regards the characteristics of radial compressibility/expandability (which are important during the bottling stage) and of interaction with the corkscrew (easy and gradual penetration, absence of risks of fragmentation, etc.) are basically determined by the core 2.

This means that the stopper according to the invention can be conveniently used in a bottling line pre-arranged for the use of stoppers made of natural cork without requiring modifications or even appreciable adjustments of the bottling-plant equipment.

Both in the case where the end surface 2a is directly exposed towards the outside of the container and in the case where the washer 4 is present, the core 2 also determines the appearance of the stopper 1 as observed from outside the container enclosed by the stopper 1 itself.

Furthermore, in the case where the portion of the jacket 3 which encloses the core 2 has quite a small thickness (for example, as in the case of the embodiment illustrated in FIG. 3), it is possible to make the jacket 3, totally or at least as regards the portion in question, with a transparent or semitransparent material. This means that the core 2 is visible from outside, thus rendering less perceptible the presence of the component of synthetic material constituted by the jacket 3.

As far as the choice of the material making up the jacket 3 is concerned, it has already been said that the solution according to the invention widens to a considerable extent the possible range of choice. Practically, the stopper according to the invention is suited to being made of any synthetic material, such as any thermoplastic elastomer that is compatible with the contents of the container (typically, in the case of foodstuffs, it must be a food-approved material) and such as to afford a good seal, preventing any leakage of the contents from or into the container closed by the stopper 1, at the same time avoiding the possibility of the risk of any phenomena of assumption or release of substances (such phenomena are likely to lie at the root of deterioration of the organoleptic characteristics of the contents of the container).

The above must be allied to a certain margin of elasticity, compatible with the action of radial compression to which the stopper 1 is subjected during its application (bottling).

A currently preferred choice is represented by a material chosen from the group consisting of polyolefins, PVC for foodstuffs, silicon rubber and thermoplastic elastomers (TPEs) comprising block-styrene copolymers.

A particularly preferred choice is represented by materials such as TPEs for the embodiments according to FIGS. 1 and 2, and polyolefins for the embodiment according to FIG. 3.

Most of the materials referred to above are suitable for application on the core 2 by direct insertion or by means of injection moulding, avoiding recourse to swelling agents of any sort, at the most resorting to a slight in-blowing of gas (such as helium, air, or other appropriate gas) that may be able to generate a certain degree of porosity and good characteristics of elastic compliance of the jacket 3.

As far as the dimensions are concerned, the experiments so far carried out by the applicant have shown that, for solutions such as those represented in FIGS. 1 and 2, the diameter dl of the core part 2 may typically be in the region of 18-20 mm as against a diameter d2 of the jacket 3 in the region of 22-25 mm.

As regards the difference, instead, between the length of insertion of the stopper 1 in the corresponding container and the homologous dimension of the core 2 (a difference that is represented by the length 11 of FIG. 1) the experiments carried out by the applicant have shown that the preferable value is in the region of 5-10 mm.

As regards, instead, the embodiment illustrated in FIG. 3, the thickness of the jacket is typically in the region of 0.2-0.4 mm in the part that envelops the skirt surface of the core 2 and preferably twice as much in the part that coats the end of the core 2 that is to be inserted into the bottle.

The values given above refer of course to the stopper in conditions free from stresses and consequently, typically, prior to bottling. of course, without prejudice to the principle of the invention, the details of construction and the embodiments may vary widely with respect to what is described and illustrated herein, without thereby departing from the scope of the present invention.

This applies in particular to the possibility of making the jacket 3 as an independent accessory, which is to be coupled to the core 2 only prior to use of the stopper 1.

1. A stopper for containers, comprising:
a core made of a natural material, such as cork; and
a coating or jacket made of synthetic material, which is adapted to coat said core at least in the parts designed to co-operate with the container to obtain a relationship of sealed closing of the container itself.

2. The stopper according to claim 1, wherein said core (2) is made of natural cork.

3. The stopper according to claim 1 wherein said jacket is made of plastic material.

4. The stopper according to claim 1, wherein said synthetic material is at least in part transparent, so that said core is at least in part visible from outside the stopper.

5. The stopper according to claim 1, wherein said synthetic material is chosen from the group consisting of polyolefins, PVC for foodstuffs, silicon rubber and thermoplastic elastomers (TPEs) comprising block-styrene copolymers.

6. The stopper according to claim 1, wherein said jacket is applied to said core by moulding.

7. The stopper according to claim 1, wherein said synthetic material is basically free from swelling agents.

8. The stopper according to claim 6, wherein said synthetic material is basically free from swelling agents, and wherein said synthetic material englobes aeriforms immitted into said synthetic material itself when the latter is moulded on said core.

9. The stopper according to claim 1, wherein said jacket is fitted onto said core by inserting said core into said jacket.

10. The stopper according to claim 1, wherein both said core and said jacket have a substantially cylindrical external conformation.

11. The stopper according to claim 1, wherein said core and said jacket have complementary formations to make a shape fit between said core and said jacket.

12. The stopper according to 1, wherein said jacket leaves one end of said core uncovered.

13. The stopper according to claim 12, wherein said end carries applied to it a covering formation made of natural material, said covering formation being visible from outside the container on which said stopper is applied.

14. The stopper according to claim 13, wherein said natural material of said covering formation is cork.

15. The stopper according to claim 2 wherein said natural material of said covering formation is cork and wherein the cork of said core and the cork of said covering formation are identical.

16. The stopper according to claim 2 wherein said natural material of said covering formation is cork and wherein the cork of said core and the cork of said covering formation are different.

17. The stopper according to claim 12, wherein said jacket extends only on part of said core, leaving a portion of said core adjacent to said end uncovered.

18. The stopper according to claim 1, wherein said stopper has a length of insertion in said container greater than a given amount with respect to the homologous dimension of said core.

19. The stopper according to claim 18, wherein said given amount is between 5 and 10 mm.

20. The stopper according to claim 17, wherein said jacket has a first thickness in the part that envelops the skirt surface said core and a second thickness, basically greater and preferably approximately twice as great, in the part that envelops the end of the core that is to be inserted into the container.

21. An accessory for making a stopper according to any one of claims from 1 to 20, said accessory being made up of said jacket as an independent element and designed to be associated to said core.
